(19) United States
(12) Patent Application Publication
(10) Pub. No.: US 2003/0202853 A1
(43) Pub. Date: Oct. 30, 2003

(54) Step drill for minimization of burrs when drilling

(76) Inventors: Sung-Lim Ko, Seoul (KR); Jae-Eun Chang, Seoul (KR)

Correspondence Address: HARNESS, DICKEY & PIERCE, P.L.C., P.O. BOX 8910, RESTON, VA, 20195, US

(21) Appl. No.: 10/235,531

(22) Filed: Sep. 6, 2002

(30) Foreign Application Priority Data
Apr. 24, 2002 (KR) 2002-22569

(51) Int. Cl. B23B 51/02

(52) U.S. Cl. 408/225

(57) ABSTRACT

A step drill minimizes burrs formed during drilling. Reducing the uncut portion of the work minimized an exit burr, which is formed by the advancing of a drill into a workpiece and increases the bending deformation during the drilling procedure of the workpiece and prolongation of cutting without bending to the end of cutting. The step drill includes a step portion formed at the front edge of the step drill. The step portion has a diameter less than a diameter of the body of the step drill and a step angle of 5 degrees through 130 degrees, and the size of the step is preferably 3% to 20% of the diameter of the body of the step drill.

### BACKGROUND OF THE INVENTION

1. Field of the Invention

The present invention relates to a step drill, and more particularly, to a step drill for minimizing burrs during drilling by changing the step angle and step diameter of a drill.

2. Prior Art

Drilling takes a large part of a cutting process. Burrs are produced by plastic deformation, which is one of the reasons for dimensional error in drilling.

These burrs are divided into an entrance burr and an exit burr. A small wedge shaped entrance burr is produced on the upper surface of a workpiece by the edge portion of a drill when the drill advances through the workpiece. The exit burr is produced on the lower surface of the workpiece by which the drill forces a part of the workpiece into a hole outside the hole before the hole is completely penetrated by the drill.

Among the various burrs, both the quality and assembly of components are seriously affected by the exit burr. Due to the exit burr, an additional de-burring process is further required. The de-burring process has been performed manually, which deteriorates work efficiency and increases the price of the product.

There are several approaches for reducing the burr, one being a method for rounding a cutting edge of a drill, and a method for increasing a helix angle and hardening an exit surface. Hardening the exit surface decreases the burr, however, which cannot be removed easily due to the hardened burr.

There are other approaches for decreasing burrs by applying ultrasonic wave and low frequency vibration, and by controlling the feed rate of drilling. These approaches have drawbacks in that since the burr is decreased according to the cutting method, a further tool for forming the hole is required so that the cost of production increases.

### SUMMARY OF THE INVENTION

Therefore, the present invention is made to solve such drawbacks of the prior art, and it is an object of the invention to provide a step drill for minimizing burrs during the drilling process by changing the shape of a drill.

The step drill of the present invention is different from the other conventional drills to accomplish the objective as shown in FIG. 1. The front edge of the step drill must first entirely penetrate a workpiece, then a secondary cutting for an uncut portion of the workpiece is performed by a step edge of the step drill. Here, by increasing the rigidity of the uncut portion against bending by adjusting a step angle of the step drill, the cutting performance can continue until the step portion is exits from the workpiece. The dimensional variation of the size of the step which is a difference between a diameter D1 of a drill body and a step diameter D2 can be varied by changing the step diameter D2 so that the uncut portion of the workpiece can be adjusted.

As shown in FIG. 1, y1 and R1 indicate critical regions where the remaining portion begins to be changed into a burr when the cutting is stopped and bending occurs. The shape of the remaining portion of the workpiece determines the critical regions. The more rigidity against the bending deformation due to a force applied at a front edge of the step drill, the more the cutting is maintained until the drill completely penetrates the workpiece and the further formation of burrs is delayed. As a result, only a small burr is formed.

Therefore, the step drill according to the present invention has a step diameter D2 that is smaller than the diameter D1 of a drill body, which includes an inclined step edge whose diameter decreases forward to the front edge of the step drill so that a burr, which is formed when the step drill penetrates the workpiece is removed by the step portion, wherein the step edge is defined by a step angle θ2, and a step size, that is, the difference between D1-D2 diameters of the drill body and the step diameter.

Here, preferably the step angle ranges from 5 degrees to 130 degrees, and the step size ranges from 3% to 20% of a diameter of the drill body.

### BRIEF DESCRIPTION OF THE DRAWINGS

These and other features, aspects, and advantages of the present invention will become better understood with regard to the following description, appended claims, and accompanying drawings, in which like components are referred to by like reference numerals. In the drawings:

FIG. 1 is a schematic drawing showing the state that a workpiece is cut by a step drill according to the present invention;

FIG. 2 are side views showing respective shapes of drills according to embodiments of the present invention and examples; wherein

FIG. 2A is a view showing a high-speed steel drill;

FIG. 2B is a view showing a carbide drill;

FIG. 2C is a view showing a chamfer drill;

FIG. 2D is a view showing a round drill; and

FIG. 2E is a view showing a step drill;

FIG. 3 is a table showing dimensions of drills according the embodiments of the present invention and the examples;

FIG. 4 is a table showing the cutting conditions in the embodiments of the present invention and the examples in FIG. 2;

FIG. 5 are graphs showing the relationship between height of a burr and feed rate of the drills that are measured in the embodiments of the present invention and the examples; wherein

FIG. 5A is a graph showing the measurement in the examples 1, 2, 3, and 4;

FIG. 5B is a graph showing the measurement in the examples 2, 5, and 6;

FIG. 5C is a graph showing the measurement in the embodiments 1 through 7 of the present invention;

FIG. 5D is a graph showing the measurement in the embodiments 8 through 12 of the present invention; and

FIG. 5E is a graph showing the measurement in the embodiments 13 through 17 of the present invention;

FIG. 6A is a cross-sectional view showing the state when the chamfer drill according to the example forms the burr;

FIG. 6B is a cross-sectional view showing the state when a round drill according to the example forms the burr;

FIG. 6C is a cross-sectional view showing the state when a step drill according to the embodiment of the present invention forms a burr;

FIG. 7 is a graph showing the relationship between the height of a burr and the workpiece in the embodiments of the present invention and the examples;

FIG. 8 is a table showing properties of the workpieces used in experiments in FIG. 7;

FIG. 9 is a table showing the cutting conditions in the experiments in FIG. 7;

FIG. 10 are views showing thrust force and torque of the step drill according to the present invention and a conventional drill during the cutting process; wherein

FIG. 10A is a view showing the cutting state by the conventional drill; and

FIG. 10B is a view showing the cutting state by the step drill according to the present invention; and

FIG. 11A through FIG. 11G are photographs showing regions 1 through 8 of the step drill in FIG. 10.

### DETAILED DESCRIPTION OF THE PREFERRED EMBODIMENT

Hereinafter, the preferred embodiments of the present invention are described in detail.

A step drill having a variable step angle and variable step diameter is used as a step drill according to the preferred embodiments of the present invention, while a high speed steel drill (HSS drill), a carbide drill, a chamfer drill, and a round drill are used as examples.

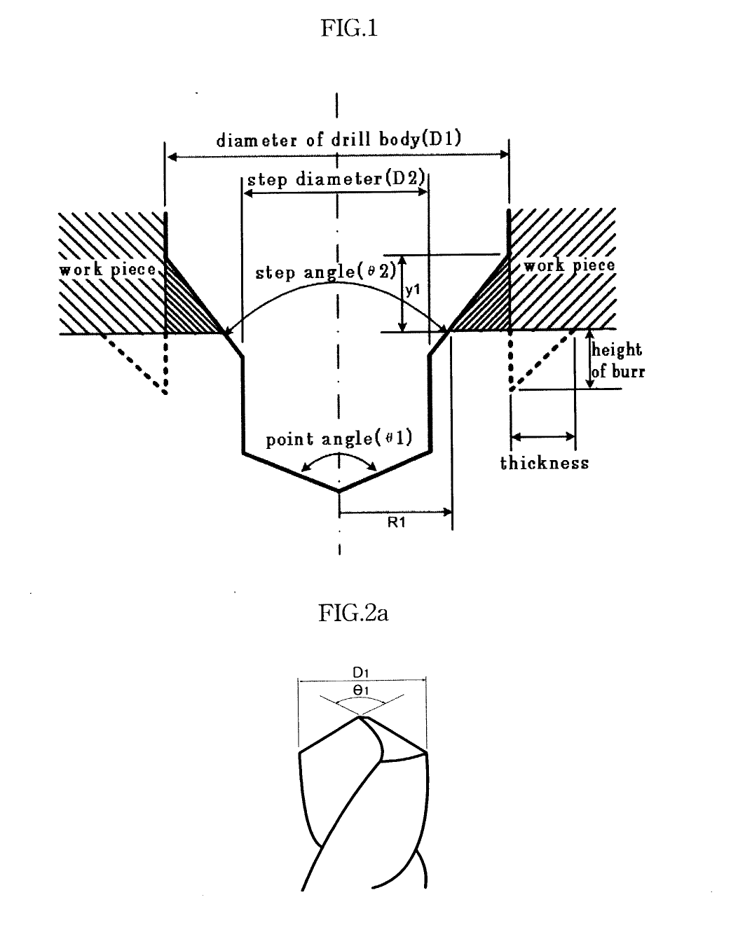

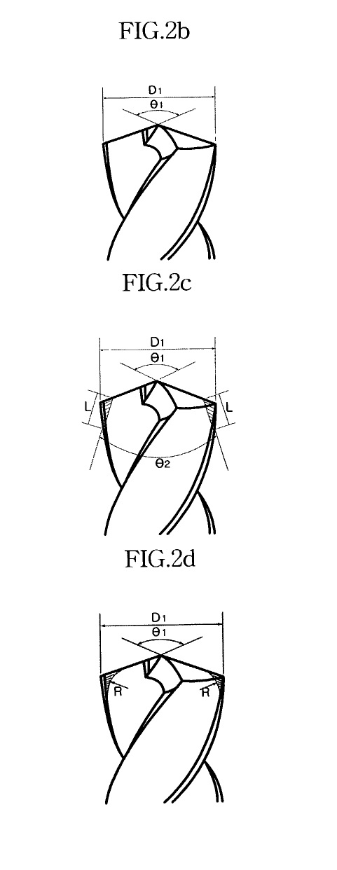

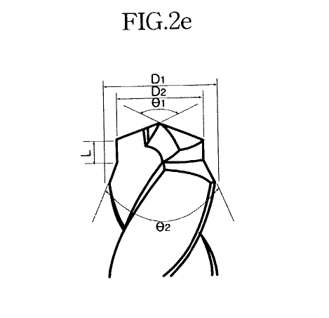

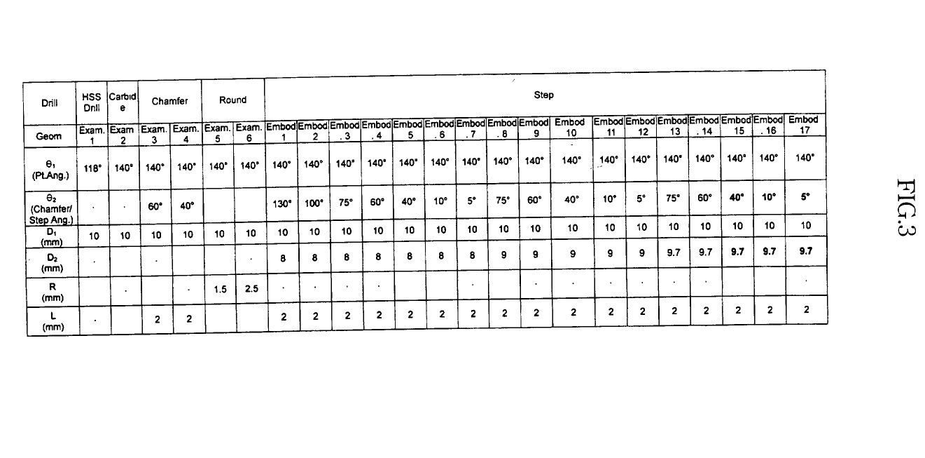

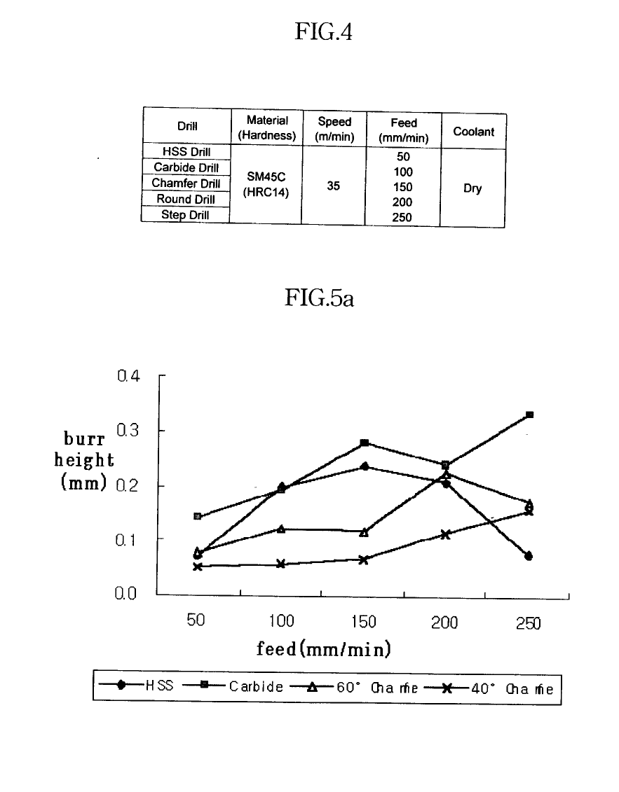

FIG. 2 shows the shapes of the step drill of the preferred embodiments of the present invention and the examples, FIG. 3 shows dimensions of the drills used in the experiments, and FIG. 4 shows the cutting conditions in the preferred embodiments of the present invention and the examples.

Drilling is performed at a CNC machining center (Hyundai SPT18S) using SM45C as a workpiece. The experiments, as shown in FIG. 4, are performed under the cutting conditions that the cutting speed is maintained constant by increasing the feed rate of the drills by five steps which is an effective factor influencing burr formation, and coolant is not used in dry drilling.

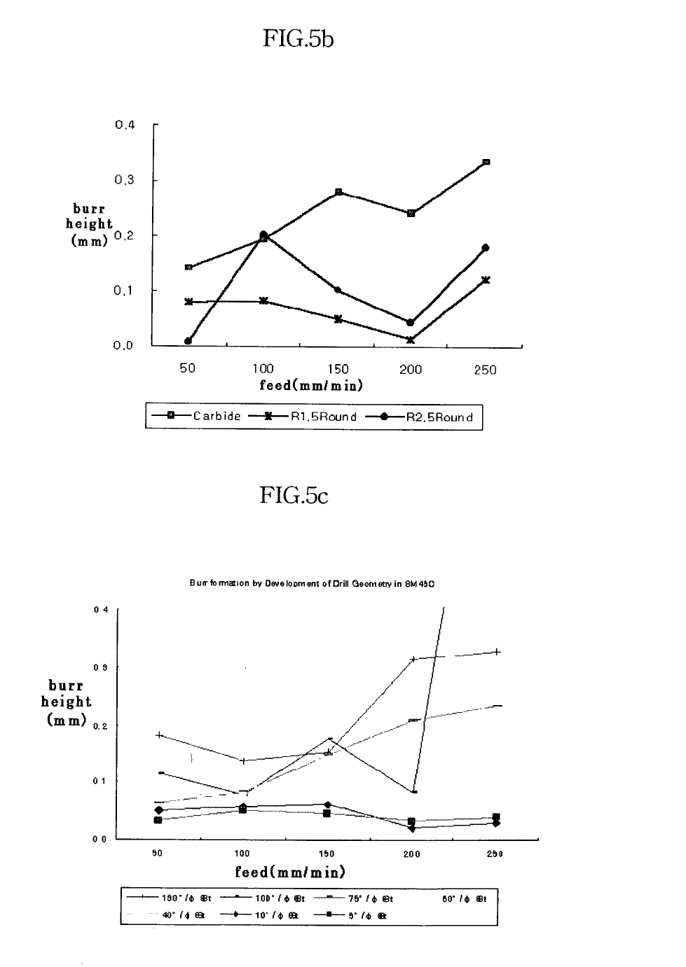

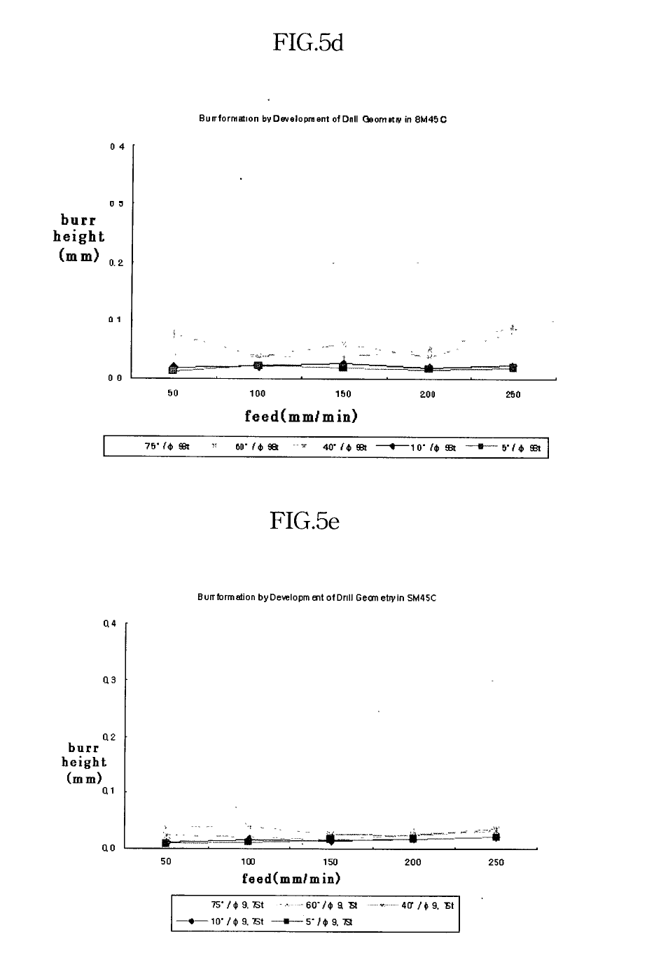

FIG. 5 is graphs showing relationships between the height of the burr and the feed rates of the drills after obtaining data for height and thickness of the burr formed in drilling by a measuring means of a non-contact laser measuring apparatus.

As shown in FIG. 5A, the experiments for examples 3 and 4 are performed with the chamfer drills having respective chamfer angles of 60 degrees and 40 degrees while having a point angle of 140 degrees. Drilling in the experiments by the chamfer drill is similar to drilling with three drills having a point angle of 140 degrees, 60 degrees, and 40 degrees, respectively. In other words, the hole of the workpiece is firstly formed by a conventional drill with a point angle of 140 degrees, and then secondly, is formed by a conventional drill with a point angel of 60 degrees and 40 degrees, respectively. Since the rigidity of the chamfer drill against bending deformation in the feed direction of the drill is greater than a conventional drill, little bending deformation due to resistance when the drill escapes the workpiece occurs. Therefore, the size of burrs in examples 3 and 4 is smaller than the size of burrs in examples 1 and 2. Since size of the uncut portion in example 4 is smaller than the size of the uncut portion in example 3, a smaller burr is formed in example 4.

Round drills with respective corner radiuses of 1.5 mm and 2.5 mm are used in examples 5 and 6. As shown in FIG. 5B, since the bending deformation of the uncut portion occurs just before the drill penetrates the workpiece in example 6, the burr formed in example 6 is greater than the burr formed in example 5.

Referring to FIG. 5C, if a drill has a step angle of 100 degrees and the feed rate of 200 mm/min, it can be understood that the height of the burr is remarkably increased.

Therefore, since it is understood that the height of the burr formed by the drills with step angles of 100 degrees and 130 degrees is remarkably higher than height of the burr formed by the drills of step angles 75 degrees, 60 degrees, 40 degrees, 10 degrees, and 5 degrees, it can be understood that if the step angle is less than 75 degrees, the height of the burr lowers in accordance with the decrease of the step angle.

There are several embodiments that are distinguished by seven step angels and three step diameters, that is, the first embodiment through the seventeenth embodiment.

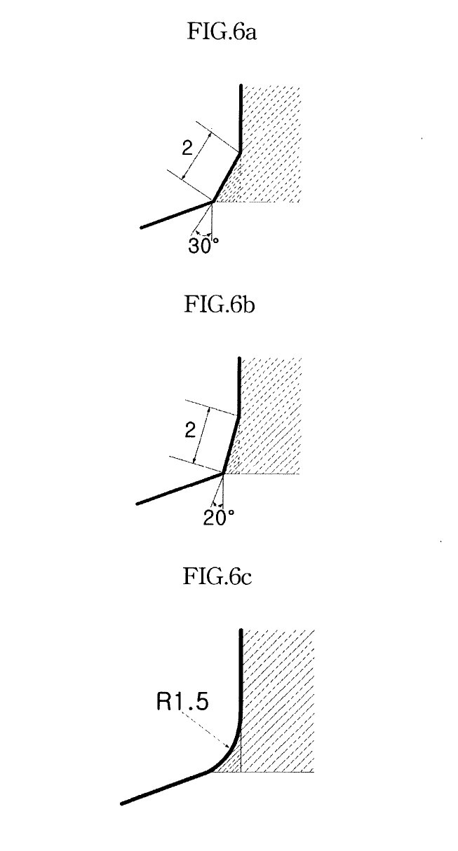

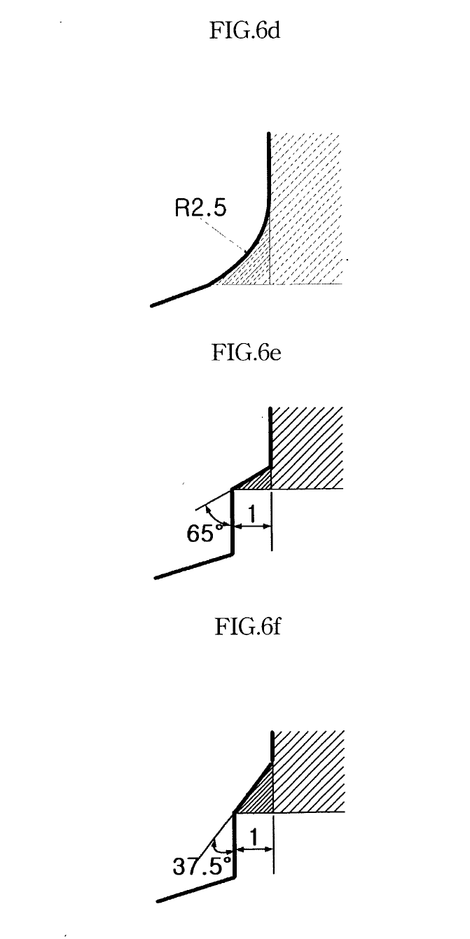

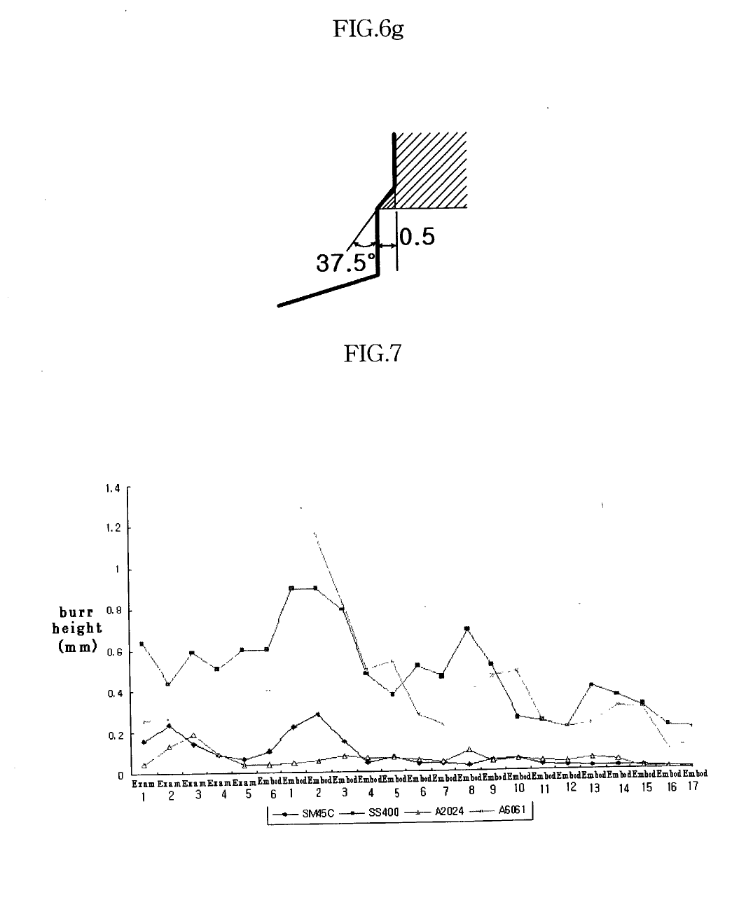

In the first and second embodiments using drills with respective step angels of 130 degrees and 100 degrees and the same step diameter of 8 mm, since the drill does not have enough rigidity in the advancing direction, a cap portion of the uncut portion, which is formed during a primary drilling, is pushed outside the hole. Thus, the size of a burst-type burr is different between the step diameter and the diameter of the drill body. However, in the third embodiment using a step drill with a step angle of 75 degrees of the present invention, since the drilling is performed to the end, a small sized burr is formed, as shown in FIG. 6C, especially in the eighth embodiment by a step drill with a step diameter of 9 mm, since the amount of the uncut portion is small, a relatively small sized burr is formed.

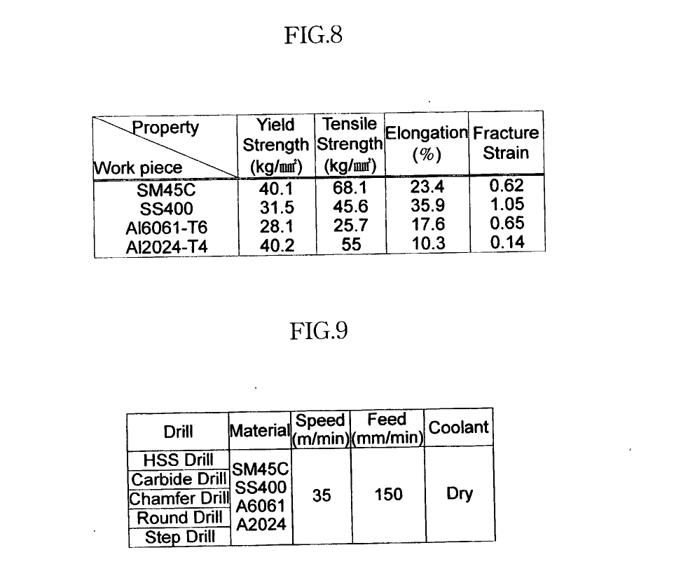

Next, characteristics of the burr that is formed from workpieces of different properties are experimented with. FIG. 8 shows a table listing the physical properties of the workpieces and FIG. 9 shows a table listing the drilling conditions (cutting conditions).

FIG. 7 shows a correlation graph of sizes of burrs formed in the examples and the embodiments of the present invention after the drilling is performed in four workpieces for experimentation.

The biggest burrs are formed from A6061 and SS400 with a burst type burr, and generally very small sized burrs are formed from A2024. Except for the workpiece, A6061 where the biggest burrs are formed, relatively small sized burrs are formed from other workpieces in the third through the seventeenth embodiments that are pernetrated by drills with step angles of less than 75 degrees.

Moreover, the characteristics of the burr formation are shown from SM45C in a most distinctive way in accordance with various types of drills. That is, since chips are easily discharged and bending due to plastic deformation is small relative to other materials with large ductility, small sized burrs can be formed.

Relatively large burrs are formed in SS400 and A6061 in comparison with other workpieces, and the size of the burrs is varied according to the step angle. In the first, second, third, eighth, and thirteenth embodiments, drills of step angles greater than 75 degrees are experimented with, but large burrs similar to a burst type burr are formed. In the fourth, fifth, sixth, seventh, ninth, tenth, eleventh, twelfth, fourteenth, fifteenth, sixteenth, and seventeenth embodiments, drills of step angles less than 60 degrees are experimented with, but small burrs are formed. The above-described results are caused by the reason that the SS400 and A6061 have a large ductility and small tensile strength in contrast to the SM45C, and the critical thickness where bending begins at the final phase in drilling is different.

As shown in the experiments with SS400, A6061, and SM45C, the height of the burr decreases according to the step angle. In addition, it is observed in the experiments with SS400 and S6061 that the height of the burr decreases as the size of the step portion of the drill is decreased from 20% (2 mm; size of one side of the step portion is 1 mm) to 10% (1 mm; size of one side of the step portion is 0.5 mm) of the diameter D1 of the drill.

Referring to FIG. 7 which is depicted in FIG. 3, it can be observed that the smallest burr is formed in all workpieces of the tenth embodiment when the drill size of a step portion is 10% (1 mm; size of one side of a step portion is 0.5 mm) of the diameter D1 of the drill and has a step angle of 40 degrees, in the eleventh embodiment using a drill of the size of a step portion of 10% (1 mm; size of one side of a step portion is 0.5 mm) of the diameter D1 of the drill and a step angle of 10 degrees, in the twelfth embodiment with a drill of the size of a step portion of 10% (1 mm; size of one side of a step portion is 0.5 mm) of the diameter D1 of the drill and a step angle of 5 degrees, in the sixteenth embodiment with a drill of the size of a step portion of 3% (0.3 mm; size of one side of a step portion is 0.15 mm) of the diameter D1 of the drill and a step angle of 10 degrees, and in the seventeenth embodiment using a drill of the size of a step portion of 3% (0.3 mm; size of one side of a step portion is 0.15 mm) of the diameter D1 of the drill and a step angle of 5 degrees.

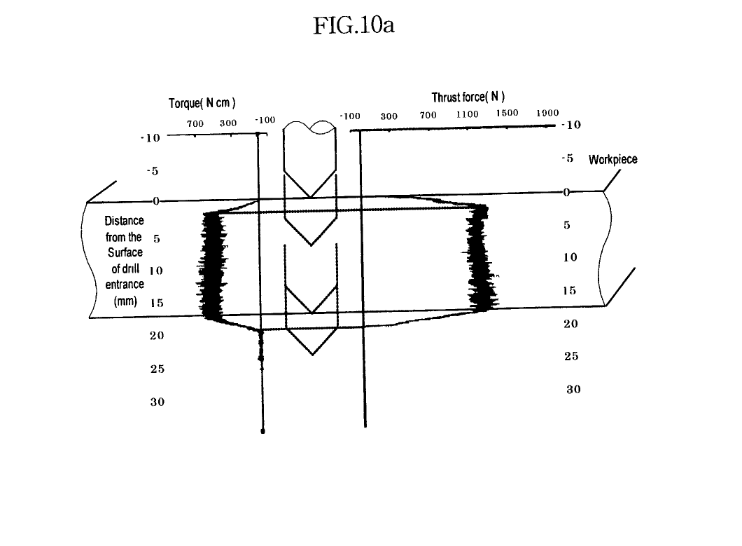

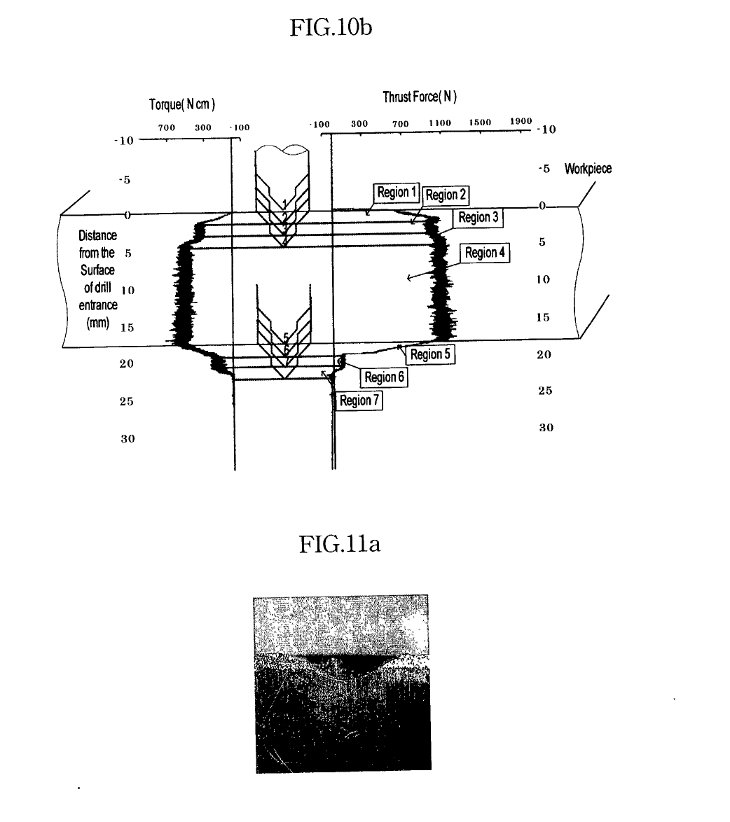

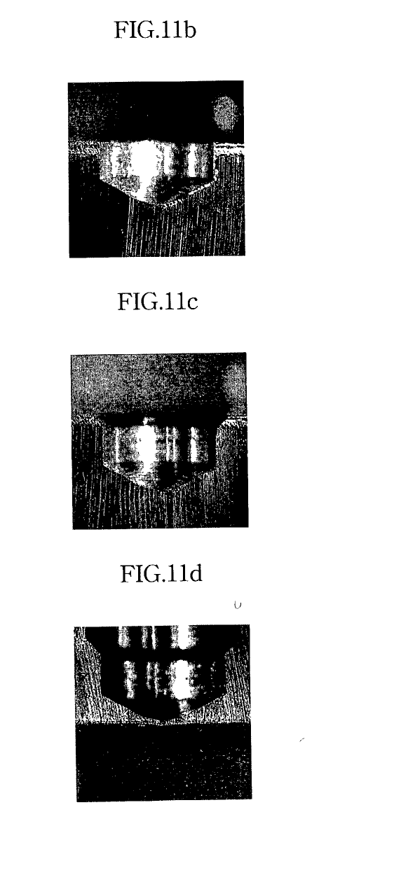

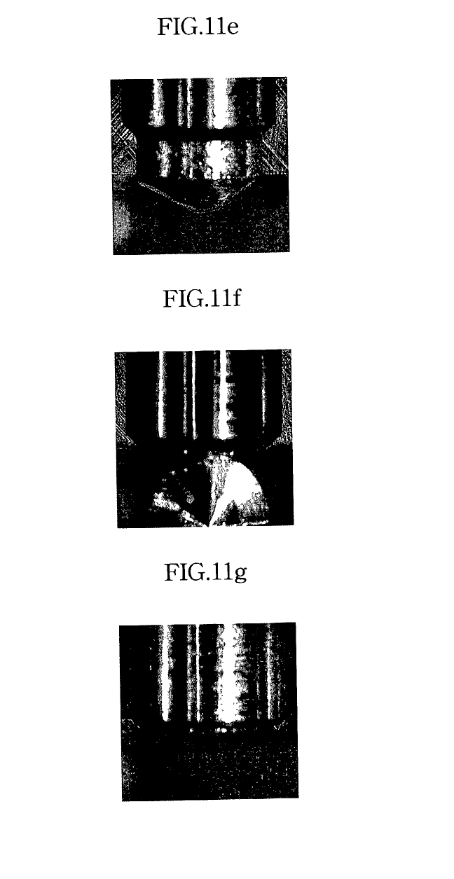

Referring to FIG. 10 which shows the torque and thrust force of the step drill according to the present invention occurring during the drilling process, and FIG. 11 showing the cutting status of the step drill of the present invention as the step drill is fed into the workpiece, the variations of the cutting force of the step drill of the present invention will be described in detail as follows:

FIG. 10A shows the cutting force of a conventional drill. As shown in FIG. 10A, during the drilling, the cutting force of the conventional drill is increased at a spot where the drill is fed into the workpiece and decreased at the penetrated spot during a constant cutting force. Meanwhile, the cutting force is maintained at a constant value while cutting inside the workpiece due to the smooth discharging of chips and steady cutting.

FIG. 10B shows the cutting force of the step drill of the present invention, and FIGS. 11A through 11G show photographs taken at the respective regions. As shown in the drawings, the cutting forces of the step drill of the present invention at regions 1 and 2 are almost the same as those of a conventional drill, and also the cutting force at region 3 where a step angle and a step portion are shown as increasing at a constant.

Region 4 is a portion where the drilling is performed by the point angle and step angle, at this region, the torque and the thrust force are increased a little as the depth of the hole being cut increases.

At region 5, the torque is decreased faster than the thrust force is decreased as the point angle passes an exit surface of the workpiece. At region 6, since the front edge already passed the exit surface of the workpiece and only the step portion of the drill affects the thrust force of the drill at region 6, the thrust force at regions 6 and 7 has a relatively higher value. A step length L, determines the length of this region; the burr formed by the front edge of the drill is still maintained while the drilling is divided into drilling at the front edge and drilling by the step portion. The magnitude of resistance at this time is determined by the size of the step portion and the step portion forms a secondary burr.

If the step angle is relatively larger than 130 degrees, the resistance rapidly decreases due to the bending deformation of the remaining portion. Since the resistance gradually decreases and the cutting volume increases when the step angle is smaller like as 40, 10, and 5 degrees, the burr is formed at a minimum.

As described above, according to a step drill of the present invention, the formation of a burr at the exit surface of the workpiece is minimized by decreasing the uncut portion of the workpiece and prolongation of cutting without bending to the end of cutting.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. A step drill comprising:
a drill body having a drill body diameter;
a step having a step diameter less than the drill body diameter;
a step portion, formed to be inclined forward to a front edge of the step drill, whose diameter is decreased forward to the front edge, the step portion removing a burr formed when the step drill penetrates a workpiece to be worked, and being defined by a step angle and a size of the step which is a difference between the drill body diameter and the step diameter.

2. The step drill as claimed in claim 1, wherein the step angle ranges from 5 degrees to 130 degrees.

3. The step drill as claimed in claim 1, wherein the step angle ranges from 5 degrees to 75 degrees.

4. The step drill as claimed in claim 1, wherein the step angle ranges from 5 degrees to 60 degrees.

5. The step drill as claimed in claim 1, wherein the step angle ranges from 5 degrees to 40 degrees.

6. The step drill as claimed in claim 1, wherein the step angle ranges from 5 degrees to 10 degrees.

7. The step drill as claimed in any one of claims 1 to 6, wherein the size of the step ranges from 3% to 20% of the drill body diameter.

8. The step drill as claimed in any one of claims 1 to 6, wherein the size of the step ranges from 10% to 20% of the drill body diameter.

9. The step drill as claimed in any one of claims 1 to 6, wherein the size of the step ranges from 3% to 10% of the drill body diameter.
